(19) United States
(12) Patent Application Publication
(10) Pub. No.: US 2010/0058912 A1
(43) Pub. Date: Mar. 11, 2010

(54) Paper punch with assistance arm

(76) Inventor: Chien-Chuan Huang, Chang Hua Hsien. (TW)

Correspondence Address: BACON & THOMAS, PLLC, 625 SLATERS LANE, FOURTH FLOOR, ALEXANDRIA, VA, 22314-1176, US

(21) Appl. No.: 12/232,032

(22) Filed: Sep. 10, 2008

(51) Int. Cl. B26D 5/08

(52) U.S. Cl. 83/621

(57) ABSTRACT

A paper punch includes a base with two support units and each support unit has lower first holes and higher second holes. A main arm has two extensions and each extension has two lugs. Each lug includes an elongate slot defined therethrough. The main arm is pivotably connected to the higher second holes. Two assistance arms are located between the main arm and the two support units, the two assistance arms are pivotably connected to the lower first holes. Each assistance arm includes two legs and each leg has a protrusion which is movably engaged with the elongate slot corresponding thereto. Two punch head are movably connected to the two support units and can be pushed to punch paper sheets by the assistance arms. The protrusions of the assistance arms move along the elongate slots in the main arm and the punch heads are lowered by the assistance arms.

### FIELD OF THE INVENTION

The present invention relates to a paper punch including a main arm and an assistance arm which increases the force applied to the punch head with less force applied to the main arm.

### BACKGROUND OF THE INVENTION

A conventional paper punch 4 is shown in FIG. 8 and generally includes a base 43 and two support plates 44 extend from the top of the base 43. An arm 42 is pivotably connected to the support plates 44 by a pin 41 and at least one punch head 45 is located between the base 43 and the arm 42. A spring is mounted to the punch head 45 so as to provide a force to move upward after the arm 42 is released. The top end of the at least one punch head 45 is located beneath the arm 42 so that when pivoting the arm 42 downward, the at least one punch head 45 is pushed downward and the blade portion on the lower end of the at least one punch head 45 penetrates through sheets of paper in the slots located beneath the at least one punch head 45.

However, it requires a significant force to punch a thick layer of paper sheets and the at least one punch head applied a strong reaction force from the paper sheets, this makes the punching action to be difficult for some users.

The present invention intends to provide a paper punch which includes assistance arm for providing an extra torque to the punch head to punch the paper sheets with less effort.

### SUMMARY OF THE INVENTION

The present invention relates to a paper punch that comprises a main arm, two assistance arms, a base and two punch heads. The main arm has two extensions and each extension has two lugs, each lug including an elongate slot defined therethrough. The base has two support units on a top thereof and the each support unit is composed of two parallel plates and a bottom plate connected between the two parallel plates. Each plate of the two support units has a first hole and a second hole which is located at a distance from the first hole. Two top plates are connected to the two support units and an aperture is defined through each of the two top plates. Two through holes are defined through the two respective bottom plates of the two support units and located in alignment with the apertures. The two extensions of the main arm are pivotably connected to the two support units at the second holes.

The two assistance arms are located between the main arm and the two support units. The two assistance arms are pivotably connected to the two support units at the first holes. Each assistance arm includes two legs and each leg has a protrusion extending from an outside thereof. The protrusions are movably engaged with the elongate slots of the main arm. The two punch heads extend through the apertures of the two support units and two springs are located between the top plates and the bottom plates. A lower end of each punch head movably extends through the through holes. A gap is defined between the two respective bottom plates of the two support units and a stepped surface of the top of the base.

The primary object of the present invention is to provide a paper punch that saves user's effort to punch thick paper sheets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the paper punch of the present invention;

FIG. 2 is a perspective view to show the paper punch of the present invention;

FIG. 3 shows a side view of the paper punch and the lengths of the arms of forces of the main arm and the assistance arms;

FIG. 4 is a diagram showing the lengths of the arms of forces of the main arm and the assistance arms;

FIG. 5 shows the operation of the paper punch of the present invention;

FIG. 6 shows the paper punch of the present invention that includes only one punch head;

FIG. 7 shows the paper punch of the present invention that includes three punch heads, and

FIG. 8 is a side view to show the conventional paper punch.

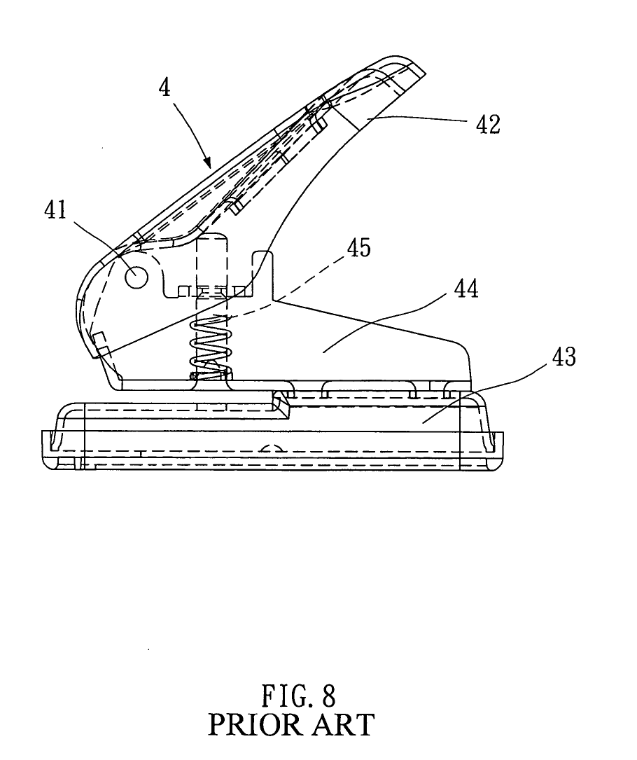

### DETAILED DESCRIPTION OF THE PREFERRED EMBODIMENT

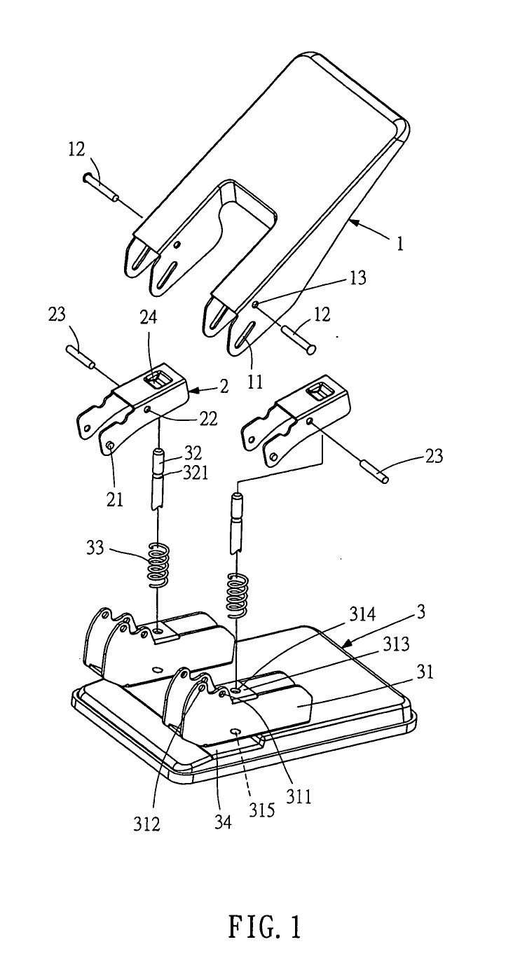

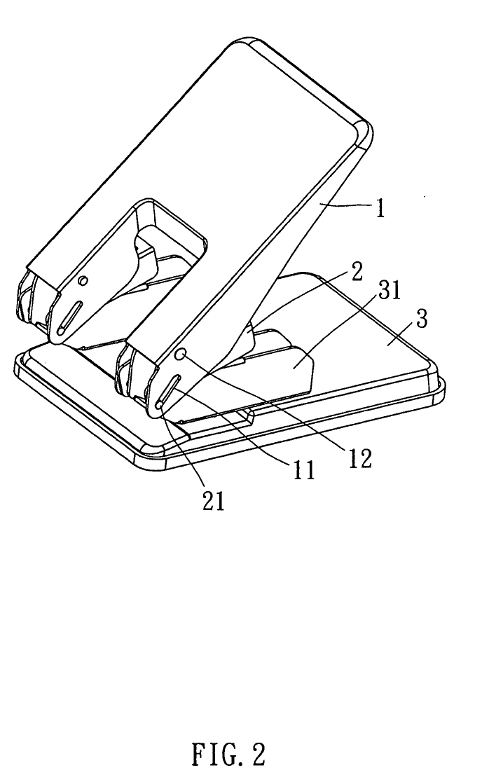

Referring to FIGS. 1 to 4, the paper punch of the present invention comprises a main arm 1, two assistance arms 2, a base 3 and two punch heads 32. The main arm 1 has two extensions and each extension includes two lugs. Each lug includes an elongate slot 11 defined therethrough. The base 3 has two support units 31 on a top thereof and each support unit 31 is composed of two parallel plates and a bottom plate connected between the two parallel plates. Each of the parallel plates of the two support units 31 has a first hole 311 and a second hole 312 which is located at a distance from the first hole 311 and lower than the second hole 312. Two top plates 313 are connected to the two support units 31 and an aperture 314 is defined through each of the two top plates 313. Two through holes 315 are defined through the two respective bottom plates of the two support units 31 and located in alignment with the apertures 314. The two extensions of the main arm 1 are pivotably connected to the two support units 31 at the second holes 312 by extending two pins 12 through two holes 13 in the two extensions and the two second holes 312. A gap 34 is defined between the two respective bottom plates of the two support units 31 and a stepped surface of the top of the base 3, so that the paper sheets (not shown) are inserted into the gap 34 and to be punched.

The two assistance arms 2 are located between the main arm 1 and the two support units 31. The two assistance arms 2 are pivotably connected to the two support units 31 at the first holes 311 by extending two pins 23 through holes 22 in the two assistance rams 2 and the first holes 311. Each assistance arm 2 includes two legs and each leg has a protrusion 21 extending from an outside thereof. The protrusions 21 are movably engaged with the elongate slots 11 of the main arm 1.

The two punch heads 32 extend through the apertures 314 of the two support units 31 and two springs 33 are located between the top plates 313 and the bottom plates. A lower end of each punch head 32 movably extends through the through holes 315 so as to punch the paper sheets in the gap 34. A top end of each of the punch heads 32 is in contact with a pushing portion 24 extending from an underside of each assistance arm 2. Each of the punch heads 32 includes a groove 321 defined in an outer periphery thereof and one end of the spring 33 on each of the punch heads 32 is engaged with the groove 321.

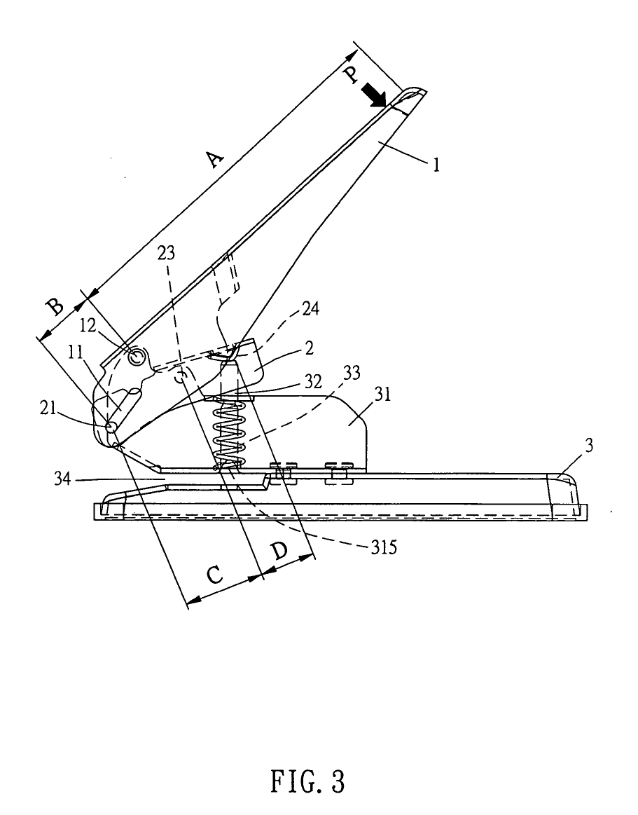

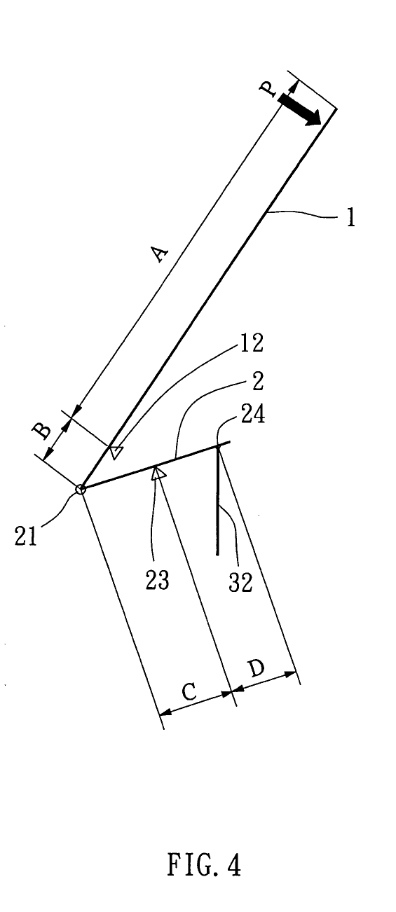

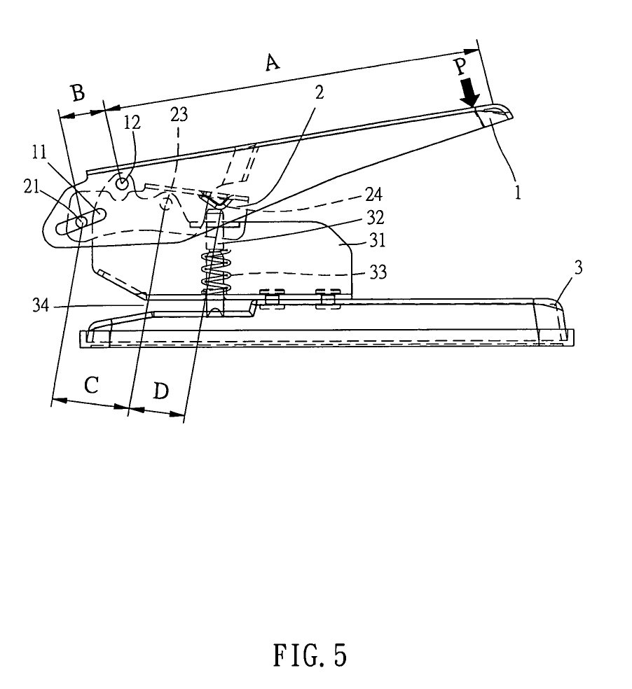

Further referring to FIG. 5, when applying a force “P” at the distal end of the main arm 1 as shown in FIGS. 3 and 4, the length of the arm for the force “P” represented by “A” which is the distance from the point that the force “P” applied on the main arm 1 to the pins 12, is longer than the length of the distance represented by “B” which is the distance from the pins 12 to the protrusions 21. Therefore, the user can easily pivot the main arm 1 and relatively move the protrusions 21 along the elongate slots 11. The movement of the protrusions 21 is done by the force applied to the lugs. The distance between the protrusions 21 to the pins 23 is represented by “C” which is longer than the distance “D” between the pins 23 to the pushing portions 24. Therefore, the assistance arms 2 are pivoted to lower the punch heads 32. The distance “A” is much longer than the distance “B” so that the force applied to the lugs is significant to pivot the assistance arms 2 to punch the paper sheets. The punch heads 32 are moved upward by the springs 33 when releasing the main arm 1.

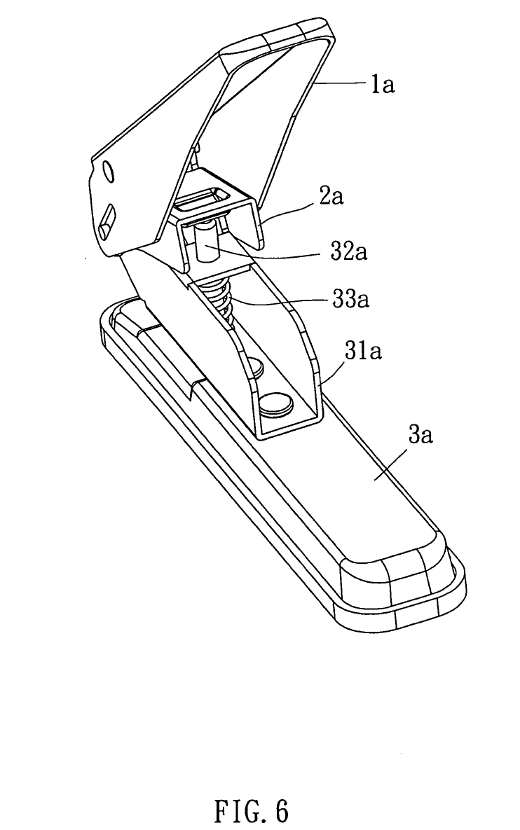

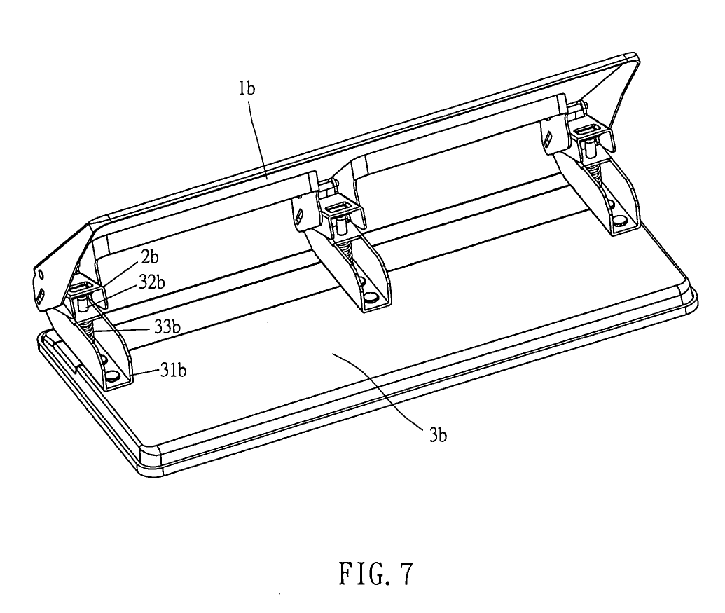

FIG. 6 shows that the paper punch can include a base 3a, one support unit 31a with one punch head 32a and one spring 33a, one assistance arm 2a and one main arm 1a. Also, as shown in FIG. 7, the paper punch can include a base 3b, three support units 31b with three punch heads 32b and three springs 33b, three assistance arms 2b and one main arm 1b.

While we have shown and described the embodiment in accordance with the present invention, it should be clear to those skilled in the art that further embodiments may be made without departing from the scope of the present invention.

What is claimed is:

1. A paper punch comprising:
a main arm having two extensions and each extension having two lugs, each lug including an elongate slot defined therethrough,
a base having two support units on a top thereof and the two extensions of the main arm pivotably connected to the two support units;
two assistance arms located between the main arm and the two support units, the two assistance arms pivotably connected to the two support units, each assistance arm including two legs and each leg having a protrusion extending from an outside thereof, the protrusions movably engaged with the elongate slots of the main arm, and
two punch heads movably connected to the two support units, two springs mounted to the two punch heads and biased between the support units and the base, the punch heads being pushed downward by the assistance arms.

2. The paper punch as claimed in claim 1, wherein each support unit is composed of two parallel plates and a bottom plate is connected between the two parallel plates, each one of the two parallel plates of the two support units has a first hole and a second hole which is located at a distance from the first hole, two top plates are connected to the two support units and an aperture is defined through each of the two top plates, two through holes are defined through the two respective bottom plates of the two support units and located in alignment with the apertures, the two punch head extend through the apertures of the two support units and the two springs located between the top plates and the bottom plates, a lower end of each punch head movably extends through the through holes.

3. The paper punch as claimed in claim 1, wherein the two assistance arms are pivotably connected to the two support units at the first holes.

4. The paper punch as claimed in claim 1, wherein the two extensions of the main arm are pivotably connected to the two support units at the second holes.

5. The paper punch as claimed in claim 4, wherein the second holes are located higher than the first holes.

6. The paper punch as claimed in claim 2, wherein a gap is defined between the two respective bottom plates of the two support units and a stepped surface of the top of the base.

7. The paper punch as claimed in claim 1, wherein a top end of each of the punch heads is in contact with a pushing portion extending from an underside of each assistance arm.

8. The paper punch as claimed in claim 1, wherein each of the punch heads includes a groove defined in an outer periphery thereof and one end of the spring on each of the punch heads is engaged with the groove.
